(19) United States
(12) Patent Application Publication
(10) Pub. No.: US 2016/0281374 A1
(43) Pub. Date: Sep. 29, 2016

(54) JOINT COMPOUND SPREADING TOOL FOR DRYWALL JOINT FINISHING

(71) Applicant: Michael Hernandez, Staten Island, NY (US)

(72) Inventor: Michael Hernandez, Staten Island, NY (US)

(21) Appl. No.: 14/967,485

(22) Filed: Dec. 14, 2015

Related U.S. Application Data
(60) Provisional application No. 62/134,544, filed on Mar. 17, 2015.

(51) Int. Cl. E04F 21/165; B29C 65/48; B29C 65/00; E04F 21/02

(52) U.S. Cl. CPC E04F 21/1652; E04F 21/026; B29C 65/48; B29C 66/05; B29L 2031/776

(57) ABSTRACT

A hand tool is provided for the application of joint compound on wall board, having a planar blade affixed to a handle. The blade has a concave arcuate working edge, wherein the concave arcuate curve extends the entire length of the working edge to each corner of the working edge. The concave arcuate working edge may be used to apply a self-feathered layer joint compound over drywall tape on planar butt joint or an inside corner joint.

### CROSS REFERENCE TO RELATED APPLICATIONS

This application claims priority to U.S. Design Pat. D719,427, issued on Dec. 16, 2014, the entire contents of which are incorporated herein by reference, and to U.S. Patent Application No. 62/134,544, filed Mar. 17, 2015, the entire contents of which are incorporated herein by reference.

### FIELD OF THE INVENTION

This invention pertains to a hand tool for the application of joint compound to drywall joints in building construction.

### BACKGROUND

Walls in building construction are typically formed from sheets of drywall nailed or screwed to a wood or metal framework. The sheets of drywall are variously referred to as plasterboard, wallboard, gypsum board, SHEETROCK®, and other names, which are generally interchangeable here. Drywall for most walls is fabricated from a gypsum core with a paper exterior that can be painted or finished with some other surface when complete. Gypsum drywall has the advantage of being fairly easy to cut, install, and finish, and imparts a degree of fire-proofness on the final construction. Other specialized wall boards are available for example, boards made from concrete for wet environments.

The joints between sheets of drywall are conventionally finished by applying a layer of joint compound, embedding a strip of drywall tape in the wet joint compound, and applying one or more additional layers of joint compound over the tape with various knives, blades, and other tools to smooth the joint compound covering the joint and tape in order to obtain a smooth finish without a visible seam. For the purposes of this disclosure, the term “joint compound” includes products known as wall mud, plaster, or spackle intended for use in covering joints. Joint compound is supplied premixed or as a powder mixed with water.

The process of smoothing the joint compound covering a wallboard joint and tape is called “feathering” or “floating” and requires substantial skill and time in order to obtain a high quality smooth finish with an invisible seam. When a joint is feathered, one or more layers of joint compound are applied to an imperfection on the surface of the wall, such as a joint between two sheets of drywall, and the joint compound over the imperfection is manually smoothed by repeated scrapings with a tool such as a taping knife, a joint knife, and/or sanding and sponging. The objective of feathering is to smoothly taper the joint compound over the imperfection.

Joint compound is typically applied with a combination of taping knives, joint knives, and putty knives, which conventionally have a straight edge on the working edge. The term “working edge” means the edge of the tool in primary contact with the wall and/or joint compound, which is typically distal from the handle of the tool.

### BRIEF SUMMARY

This invention discloses a tool that improves the feathering or floating process in applying joint compound to joints in the finishing of walls in construction. Also disclosed are methods of using the inventive tools to apply joint compound to butt joints and inside corner joints.

In an embodiment, the tool may be a drywall taping knife with a planar blade affixed to a handle, the blade having a concave arcuate working edge distal to the handle, wherein the working edge has a corner on each end of the working edge and the concave arcuate curve extends the entire length of the working edge to each corner, and wherein the blade has two side edges on each side of the working edge.

In an embodiment, the tool may be a joint knife with a planar blade affixed to a handle, the blade having a concave arcuate working edge distal to the handle, wherein the working edge has a corner on each end of the working edge and the concave arcuate curve extends the entire length of the working edge to each corner.

In an embodiment, a method is provided for applying joint compound to a butt joint between two wall boards that form a planar surface, by applying a layer of joint compound to the butt joint, a layer of tape, and a second layer of joint compound, wherein the tool as disclosed herein with a concave arcuate working edge is pulled along the joint so the corners of the working edge of the tool are in contact with the planar surface and aligned approximately perpendicularly to the direction of the pulling. The pulling of the tool may be angled at an angle defined by the surface of the wall, the corners of the working edge of the tool, and the plane of the blade, to spread and self-feather the second layer of joint compound over the tape.

In an embodiment, a method is provided for applying joint compound to an inside corner joint between two wall board surfaces, wherein the surfaces are in an approximately perpendicular orientation between the two surfaces, by applying a layer of joint compound to each corner surface of the corner joint, a layer of tape to each corner surface, and a second layer of joint compound over the tape, and pulling the tool as disclosed herein with a concave arcuate working edge along the axis of the edge. The pulling of the tool may be crabbed slightly by keeping the distal corner of the working edge slightly behind the proximal corner of the working edge such that the proximal edge of the blade is not in direct contact with the other approximately perpendicular surface of the inside corner. The pulling of the tool may form an angle defined by a surface of the wall, the corners of the working edge of the tool, and the plane of the blade, to spread and self-feather the layer of joint compound over the corner bead.

### DESCRIPTION OF THE DRAWINGS

FIG. 1A is a perspective view of a drywall taping knife embodiment of this invention.

FIG. 1B is an elevation view of a drywall taping knife embodiment of this invention.

FIG. 2A is a perspective view of a joint knife embodiment of this invention.

FIG. 2B is an elevation view of a joint knife embodiment of this invention.

FIG. 3 is a perspective view of a method of applying joint compound to a butt joint.

FIG. 4 is a cross section view of a finished butt joint.

FIG. 5 is a perspective view of a method of applying joint compound to an inside corner joint.

FIG. 6 is a cross section view of a finished inside corner joint.

### DETAILED DESCRIPTION

This disclosure provides tools and methods that may be useful for the application of joint compound to butt joints and inside joints of drywall construction. The inventive tool may be provided in the format of a tape knife, a joint knife, or similar tool, and has a concave arcuate curved working edge in which the arcuate curve extends the entire length of the working edge. As this tool is dragged along a seam in dry wall construction to spread joint compound, the concave arcuate curve smooths the joint compound, self-feathering the joint compound over the drywall tape.

Previous disclosures have provided distinctly different approaches to the problem of feathering joint compound or plaster over drywall seams. For example, U.S. Pat. No. 2,800,672, discloses a complex device for applying plaster to drywall with two blades in which a blade with a curved edge is slidable between a working and non-working position to apply a curved layer of plaster, but not a layer that is self-feathered.

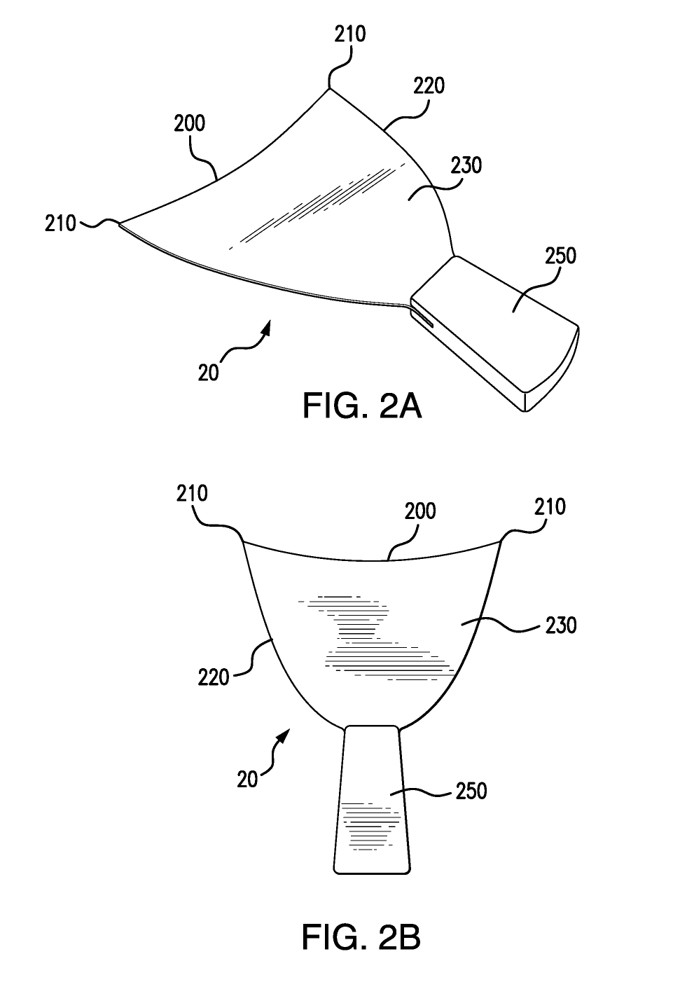

US patent publication 2002/0002754 discloses drywall tools with a concave portion on the working edge, but having flat portions (see FIGS. 2, 16a and 16b).

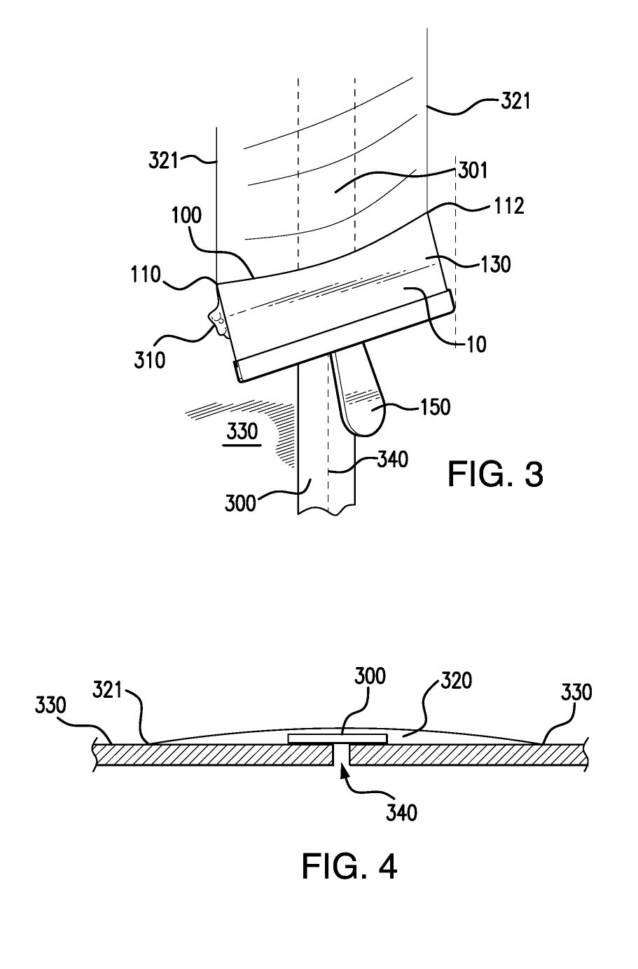

US patent publication 2008/0295435 discloses drywall tools with various curved edges. FIG. 3A in the '435 publication appears to disclose a working edge with a concave portion (item 340 and 340′), but requiring non-concave portions on the ends (item 335 and 335′). In addition, tool in the '435 publication has an arched blade, not a planar blade as in the invention disclosed herein ('435 FIG. 3b).

U.S. Pat. No. 7,647,668 provides taping knives and joint knives with a notched portion on the working edge to aid in making flat and even drywall joints.

As disclosed herein, a hand tool is provided for the application of joint compound on wall board, with a planar blade affixed to a handle, the blade having a concave arcuate working edge distal to the handle, wherein the working edge has a corner on each end of the working edge and the concave arcuate curve extends the entire length of the working edge to each corner, and wherein the blade has two side edges on each side of the working edge.

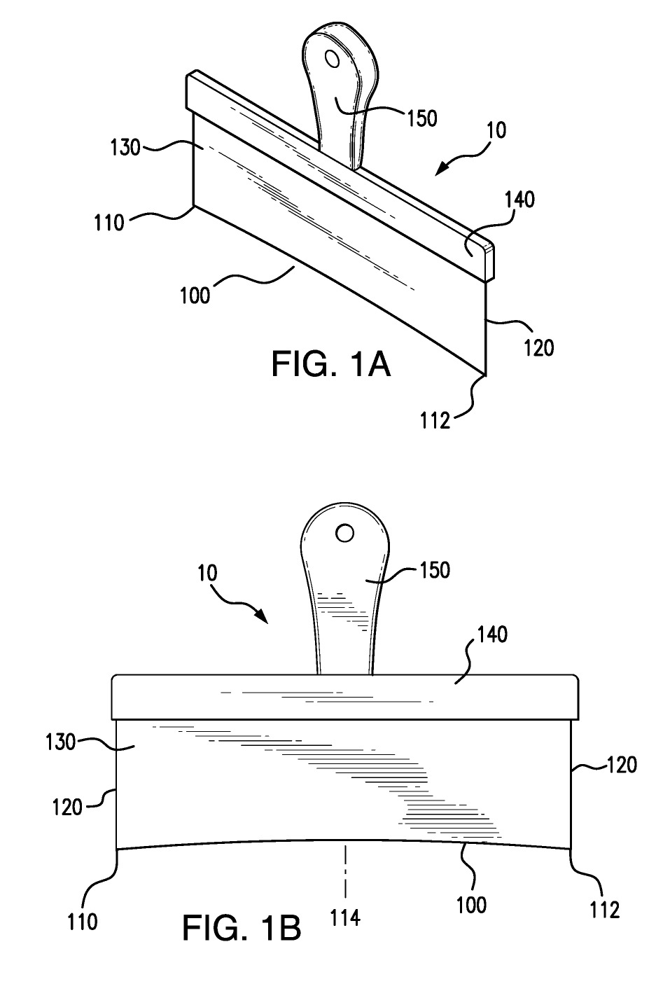

FIGS. 1A and 1B illustrate a taping knife embodiment (10) of this invention. In this embodiment, a planar blade 130 has a concave arcuate working edge 100, wherein the arcuate curve extends completely to corner edges 110 and 112. The blade has side edges 120. The blade is mounted in blade mount 140. Handle 150 is affixed to blade mount 140.

The working edge 100 in FIGS. 1A and 1B is defined by corners 110 and 112, and by center point 114. Center point 114 is equidistant between corners 110 and 112. The working edge 100 is not a straight line, but rather defines a concave shape, with an inwardly curved profile, as depicted by the elevation view in FIG. 1B. The inward arch of the curve of working edge 100 is curved towards the handle 150. Thus, because of the concave arcuate curve of working edge 100, if tool 10 was placed in an approximately perpendicular orientatation to a planar flat level surface, such that corners 110 and 112 were in contact the surface, center point 114 would be elevated above the surface by several millimeters. Center point 114 would not be in contact with the planar surface.

In the taping knife embodiment, the planar blade 130 of the tool is approximately rectangular wherein the working edge and edge bearing the handle form the longer dimension of the rectangle. Drywall taping knives are typically supplied in 6 in. (15 cm), 8 in. (20 cm), 10 in. (25 cm), 12 in. (30 cm), and 14 in. (36 cm) widths. The blades are typically made of steel that is about 0.15 mm to about 1.0 mm thick. Other materials may be used for the blade, for example, aluminum or plastic, if they are sufficiently stiff.

FIGS. 2A and 2B illustrate a joint knife embodiment (20) of this invention. In this embodiment, a planar blade 230 has a concave arcuate working edge 200, wherein the arcuate curve extends completely to corner edges 210. The blade has side edges 220. The blade is mounted on handle 250. Joint knives are typically supplied in 4 in. (10 cm), 5 in. (12.5 cm), and 6 in. (15 cm) widths.

In the joint knife embodiment 20, the blade is elongated and forms an approximate trapezoid, wherein the concave arcuate working edge defines the long edge of the approximately trapezoidal shape and the handle is affixed to the edge distal from the working edge.

In an embodiment, a tool according to this invention may be used to self-feather the application of joint compound to a taped butt joint 340 between two sheets of drywall. In an embodiment, a butt joint may be finished using the inventive tool by applying a layer of joint compound to the joint (not shown) and embedding joint tape 300 in the layer of joint compound so that the tape covers the seam between the two sheets. A conventional joint or tape knife may be used in this step. The joint compound in this step is smoothed with the knife and may be allowed to dry.

In a second step of this embodiment, a larger quantity of joint compound is applied using an inventive tape knife 10. A fairly thick layer of joint compound may be smeared over a length of the taped joint. A tape knife 10 according the instant invention, with a concave arcuate curvature along the working edge of the blade, is run along the joint.

With a butt joint along a vertical or horizontal seam 340 (FIGS. 3 and 4) (the gap between the two sheets of drywall 330 is exaggerated in FIG. 4 for clarity; more typically, the two sheets of drywall will be in contact with each other along the seam 340 of the joint), the direction of the pulling of the tape knife 10 will be along the seam with the blade corners 110 and 112 aligned in a perpendicular orientation to the seam, as shown in FIG. 3. By adjusting the angle of the blade with respect to the wall surface, the thickness of the layer of joint compound 320 may be adjusted. The angle of the blade for this purpose is defined by the plane of blade 130 and the wall surface 330, with the vertex the being an imaginary straight line between edges 110 and 112 of the working edge of the blade. The ends of the layer of joint compound 321 will be defined by the edges of the blade 110 and 112.

By using this technique with tool 10, a clean self-feathered layer 320 of joint compound with clean edges 321, and requiring minimal sanding or sponging as compared with conventional feathering techniques, may be obtained. The joint tape 301 (FIG. 3) is smoothly covered by the joint compound. Optionally, a third layer of joint compound may be applied, often called a finish coat, with a wider knife 10 than is used in the second coat of joint compound.

In the conventional application of joint compound, the user must manually adjust pressure on the knife to feather the joint and obtain a smooth finish. This typically requires sponging of the surface, while still wet, and sanding once dry, to obtain a perfectly smooth finish. By using the tool of the instant invention, the application of a smooth coat of joint compound with the tools is much more efficient, resulting in less of a need for sponging or sanding when complete.

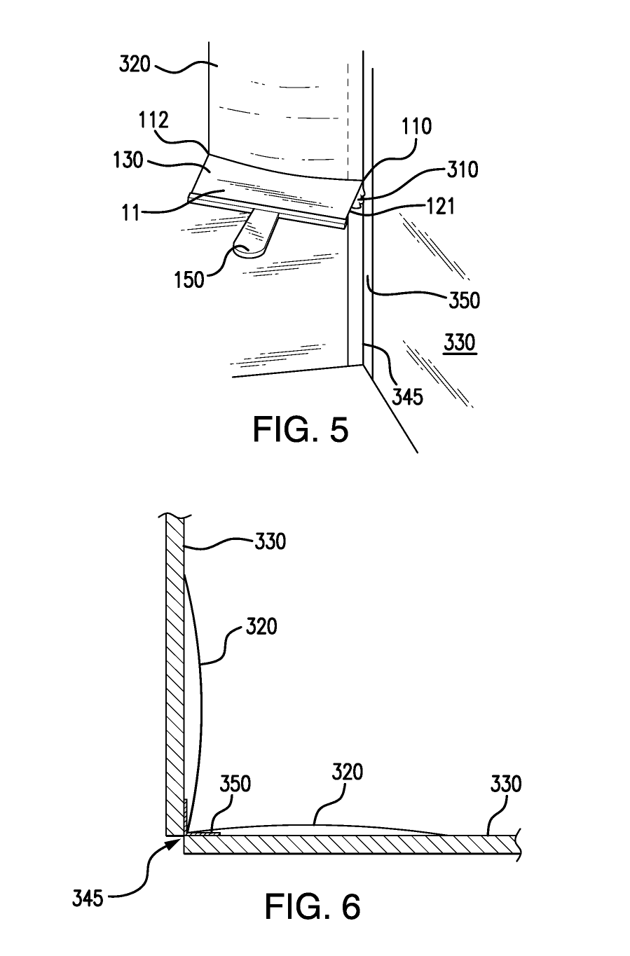

In another embodiment, the tools 10 and 20 as disclosed herein can be used to evenly spread joint compound on inside corner joints. In an embodiment, two edges of drywall forming an inside corner 345 (FIGS. 5 and 6) are provided. For clarity in this explanation, the two surfaces can be described as being on an X and Y axis, and forming an X and Y surface according to basic geometry conventions, when viewed in cross section as shown in FIG. 6.

A layer of joint compound may be applied to the edge of each X and Y surface, and drywall tape 350 is applied to the corner. Many types of drywall tape are provided with a crease along the centerline, allowing the tape to be folded 90° along the center line, so that a single strip of tape fits evenly along both X and Y surfaces in the corner. Using a joint knife, the tape 350 is embedded in the layer of joint compound with one half the tape (along the long axis) in contact with the X surface, and one half the tape in contact with the Y surface, with the centerline of the tape nested in edge 345.

In a second step of this embodiment, shown in FIG. 5, a second quantity of joint compound is placed along one side of the joint. For convenience only, this will be referred as the X surface. A taping knife 10 or joint knife 20, according to the instant invention, is then run along the X surface with inside corner 110 of tool blade 130 in intimate contact with the inside of edge 345. A quantity of excess joint compound 310 is pulled under tool blade 130.

As tool 10 is pulled along the seam of corner 345, a smooth, self-feathered layer 320 of joint compound will be established along the X surface, covering tape 350 with a smooth layer of joint compound.

In an embodiment, tool 10 may be crabbed slightly while it is pulled along the X surface in the corner, so that outside corner 112 of blade 130 is slightly behind inside corner 111. In this configuration, the inside (or proximal) blade edge 121 is not in contact with the Y surface. Tool 10 may be pulled at an angle relative to the X surface 330, defined by handle 150 corner 112, and surface 330 that can be adjusted to adjust the thickness of joint compound layer 320.

In this embodiment, a similar technique is employed to apply a self-feathered layer of 320 of joint compound on the Y surface. Thus, after a self-feathered layer of joint compound is applied to the X surface, a quantity of joint compound is then applied to the Y surface of the joint, and tool 10 or 20 is pulled along the Y surface with inside corner 112 in contact with the corner. The tool is crabbed slightly to the inside edge 310 is not in contact with the X surface. This procedure will apply a smooth layer of joint compound 320 to the Y surface.

The result is shown in cross section in FIG. 6, depicting two sheets of drywall 330 joined with an inside corner joint, and smooth feathered layers of drywall mud 320 spread over the corner tape 350.

1. A hand tool for the application of joint compound on drywall, comprising a planar blade affixed to a handle, the blade having a concave arcuate working edge distal to the handle, wherein the working edge has a corner on each end of the working edge and the concave arcuate curve extends the entire length of the working edge to each corner, and wherein the blade has two side edges on each side of the working edge.

2. The tool of claim 1 wherein the planar blade is approximately rectangular wherein the working edge and edge bearing the handle form the longer dimension of the rectangle.

3. The tool of claim 1 wherein the blade is elongated and forms an approximate trapezoid, wherein the long edge is the concave arcuate working edge and the handle is affixed to the blade distal from the working edge.

4. A method for applying joint compound to a butt joint between two drywall boards that form a planar surface, comprising
a. applying in sequence a layer of joint compound to the butt joint, a layer of tape, and a second layer of joint compound,
b. wherein the tool of claim 1 is pulled along the joint so the corners of the working edge of the tool are in contact with the planar surface and aligned approximately perpendicularly to the direction of the pulling, and
c. wherein the pulling of the tool forms an angle defined by the surface of the wall, the corners of the working edge of the tool, and the plane of the blade, to spread and self-feather the second layer of joint compound over the tape.

5. A method for applying joint compound to an inside corner joint between two drywall board surfaces, wherein the surfaces are in an approximately perpendicular orientation between the two surfaces, comprising
a. applying a layer of joint compound to each corner surface of the corner joint, a layer of tape to each surface aligned with the corner, and a second layer of joint compound over the tape,
b. pulling the tool of claim 1 along the axis of the edge so a proximal corner of the working edge of the tool abuts the approximately perpendicular wall board surface and the distal corner of the working edge in is contact with the wall surface,
c. wherein the pulling of the tool is crabbed slightly by keeping the distal corner of the working edge slightly behind the proximal corner of the working edge such that the proximal edge of the blade is not in direct contact with the other approximately perpendicular surface of the inside corner;
d. wherein the pulling of the tool forms an angle defined by a surface of the wall, the corners of the working edge of the tool, and the plane of the blade, to spread and self-feather the layer of joint compound over the corner bead; and
e. wherein steps b-d are repeated for the other side of the corner.
